(19) United States
(12) Patent Application Publication
(10) Pub. No.: US 2023/0377456 A1
(43) Pub. Date: Nov. 23, 2023

(54) MOBILE REAL TIME 360-DEGREE TRAFFIC DATA AND VIDEO RECORDING AND TRACKING SYSTEM AND METHOD BASED ON ARTIFICAL INTELLIGENCE (AI)

(71) Applicant: Darryl Kenneth Paschall, Hedgerley Green (GB)

(72) Inventor: Darryl Kenneth Paschall, Hedgerley Green (GB)

(21) Appl. No.: 18/031,027

(22) PCT Filed: Oct. 19, 2021
(86) PCT No.: PCT/US2021/055509

§ 371 Date: Apr. 10, 2023

Related U.S. Application Data
(60) Provisional application No. 63/093,816, filed on Oct. 20, 2020.

(51) Int. Cl. G08G 1/01; G08G 1/04; G08G 1/054; G08G 1/017; G06V 20/40; G06V 10/82; G06V 10/774; G06V 10/764; G06V 20/58

(52) U.S. Cl. CPC G08G 1/0112; G08G 1/04; G08G 1/054; G08G 1/0175; G08G 1/0133; G06V 20/44; G06V 10/82; G06V 10/774; G06V 10/764; G06V 20/58

(57) ABSTRACT

A mobile real-time 360-degree traffic data and video recording and tracking system and method based on Artificial Intelligence (AI) is disclosed. More particularly, a system of video cameras and other data sensors are mounted on a vehicle that capture information on all sides (360-degrees) from the vehicle. The captured information is input to a computer programmed using Artificial Intelligence to analyze the information for possible traffic infractions and report that information to authorities.

### FIELD OF THE INVENTION

The invention relates to a mobile real-time 360-degree traffic data and video recording and tracking system and method based on Artificial Intelligence (AI). More particularly, the invention relates to a system of video cameras and other data sensors mounted on a vehicle that capture information on all sides (360-degrees) from the vehicle. The invention further relates to inputting the detected information to a computer which includes a computer system programmed using AI to analyze the information for possible traffic infractions and report that information to authorities.

### BACKGROUND OF THE INVENTION

Traffic infraction detection systems known today utilize cameras, lasers and radar to detect speeding, stop sign infractions, red light infractions, bus lane infractions, wrong-way driving, left turn infractions and parking infractions in addition to license plate recognition. Such systems are typically stationary as they are mounted in certain areas, limiting the scope of information to the area around the mounting site. Some systems, such as the LogiPix™ system (<www.logipix.com>), further include computer programming that analyzes the information for specific infractions, which can be exported to authorities.

While certain infractions can be ascertained by reviewing video, such as the running of a red light or an improper right or left turn, other infractions require analysis of additional data. For example, tailgating or driving under the influence require other factors to be analyzed, such as swerving, speeding and slow driving over a period of time. Further road hazards such as potholes and flooding may not be easily detectible from stationary mounted cameras.

### SUMMARY OF THE INVENTION

The system and method of the invention comprises a plurality of cameras and other data sensors that are mounted on a vehicle which gather information on other vehicles and road conditions in the vicinity of the vehicle. The information is fed to a computer system that has been programmed utilizing Artificial Intelligence (AI) to analyze the information for traffic infractions, which can then be reported to authorities along with the underlying information. The cameras are mounted around the vehicle providing 360-degree recording of surrounding vehicles. The cameras store the information in a memory which can be transmitted to a remote computer either in real time or when a Wi-Fi® signal is available. The cameras record both audio and video. Other sensors can include radar, LIDAR and lasers to detect speed, which information is also transmitted to the remote computer. The timing of the audio and video from the camera and the sensed data from the other sensors is time synched.

The programmed computer may be local in the vehicle, or the programmed computer may be located in a remote computer. The computer is programmed such that it analyzes the received information for traffic infractions. The conclusions that a traffic infraction has occurred along with the underlying information is transmitted from the programmed computer to authorities or any other person or entity designated by the user of the system.

Further, road hazards such as potholes and flooding can be detected by the cameras in the vehicle and reported to road safety authorities.

### BRIEF DESCRIPTION OF THE DRAWINGS

The invention is described in conjunction with the following drawing.

FIG. 1 depicts a schematic of a system where the programmable computer is located in the vehicle.

FIG. 2 is an orthogonal projection of a vehicle showing placement of cameras and modules according to one embodiment of the invention.

### DETAILED DESCRIPTION OF THE INVENTION

The system and method of the invention comprises a plurality of cameras and other data sensors that are mounted on a vehicle which gather information on other vehicles and road conditions in the vicinity of the vehicle. In one embodiment, cameras are mounted on the vehicle on the bow (front); driver-side (port); rear (stern); and passenger side (starboard) of the vehicle facing outward. Additional cameras may be mounted on the vehicle from other positions, and also may include cameras to record the interior of the vehicle. In one embodiment, the cameras recording the interior of the vehicle record vehicle data such as speed and direction. In one embodiment, the cameras record video only. In one embodiment, the cameras record audio and video. In one embodiment, the cameras capture the license plates of vehicles. In one embodiment, the cameras capture street names. In one embodiment, the cameras capture the images of vehicles in the vicinity of the vehicle on which the system is mounted. In one embodiment, GPS data of the vehicle on which the system is mounted may be recorded.

In one embodiment, information from the cameras and sensors are transmitted wirelessly to the system for storage in a database. In one embodiment, one or more of the cameras and sensors are hard-wired to the system.

Other sensors may be mounted on the vehicle in addition to cameras. Such sensors include laser, radar and/or LIDAR. In one embodiment, the laser, radar and/or LIDAR detect speeds of vehicles at a plurality of time data points.

In one embodiment, the system is active upon starting of the vehicle on which it is mounted. In one embodiment, the system must be activated before it is available for use.

Information may be enhanced with information from other sources, such as weather reports, data taken from stationary mounted cameras and sensors, and data taken from aerial sources. In one embodiment, an aerial source may be a drone. In one embodiment, the information is synched with generally available information such as mapping software, for example Google® Maps.

Information detected and recorded by the cameras and sensors is fed to a programmed computer. The information from the various cameras and sensors are time stamped to synchronize the time the information was detected. The computer is programmed to analyze the information for traffic infractions, which can then be reported to authorities along with the underlying information. The computer may be programmed using machine-learning (ML) algorithms and/or artificial intelligence (AI). The computer may further be programmed with relevant standards and laws for the geographic area where the information is recorded. Such relevant standards and laws may include speed limits and laws regarding, for example, the wearing of helmets by motorcyclists, and also parking restrictions for various locations. The computer may be programmed by any programming language now known or later developed. The system may be resident on any type of computer device, including desktop computers, mainframe computers, mobile applications on smart phones and mobile applications on smart tablets and notebooks. The system may operate on web-based applications designed for example using HTML, CSS, JQuery, Javascript or PHP. The information may be stored in a database in the back-end using for example MySql.

In one embodiment, the programmed computer may comprise a system on a chip (“SOC”). In one embodiment, the programmed computer may comprise a computer programmed to emulate a SOC.

The computer will be programmed using AI where it will be provided with a plurality of various conditional data sets of regular driving patterns and data which will be considered the baseline data point. These baseline data points provide the programmed computer of the lawful condition for a particular rule, for example, driving along a highway at the proper speed. The data sets will comprise examples that are indicated as a “negative event” or a non-offense. The data sets will further comprise examples that are indicated to be “positive events.” Based on the data sets, the programmed computer will “learn” to discern between a negative event and positive event.

This process of “learning” will be repeated for each individual infraction, and according to the applicable rules and laws in various geographic jurisdictions. Further, as rules and laws change, the programmed computer may be reprogrammed in a similar fashion to reflect those changes.

As the programmed computer “learns” its results will eventually only be randomly viewed by humans to confirm that it is operating within programmed parameters as well as to minimize false positive events.

When the system determines a “positive event” has occurred according to its programming, the programmed computer will ascertain a pre-determined and post-determined time frame of the positive event and blend it with the cameras and sensors involved to create a video of the positive event. The video may include additional time frames before and after the positive event. Additionally, other information from the sensors may be associated in a file with the video showing information such as license plate information of surrounding vehicles.

Initially, in one embodiment a human operator of the system will notate positive events and negative events and collate the videos of these events by hand. The hand-collated videos will be provided to the programmed computer as examples of “positive events” and “negative events” to further the ability of the system to distinguish the differences.

The system will then assign a number to the infraction and send that as a link to assigned authorities so they can review and issue citations accordingly. The data can be stored on servers required and approved by the authorities in that geographic jurisdiction for a pre-determined time. The data may be viewable only to the authorities as well as the registered owner(s) of the vehicle(s) in the videos. Links provided to authorities can be encrypted.

In one embodiment, reviewers of the data and the programmers of the AI or any of the people involved in data collection and collation will not have access to the private information of anything shown in information being collected. In one embodiment, recorded information may be considered public domain and the various tools being utilized for data collection may be available to the general public.

Infractions that may be detected may be simple to ascertain by review of the video and or laser/radar/LIDAR information such as improper lane changes; improper lane changes; improper U-turns; illegal left turns and right turns; running of red lights and stop signs; improper parking; driving with a helmet for motorcyclists; speeding; and failure to yield to pedestrians. Other infractions may be detected by analysis of a combination of information from various cameras and sensors. For example, driving under the influence may be analyzed by a variety of factors such as slow or fast speed, erratic driving such as crossing a center line or crossing into adjacent lanes and swerving. Tailgating may be detected by detecting the relative speeds of vehicles and the distances over a period of time.

The cameras and sensors are mounted around the vehicle providing 360-degree recording of surrounding vehicles. The cameras store the information in a memory which can be resident in the vehicle. The information can later be transmitted to a remote computer either in real time or when a Wi-Fi® signal is available. In one embodiment, information that may be subject to privacy laws, such as GDPR, may be transferred in real time when the cameras and sensors are physically in communication with the database and/or programmed computer.

A conclusion made by the programmed computer that a traffic infraction (a “positive event”) has occurred along with the underlying information is transmitted from the programmed computer to authorities or any other person or entity designated by the user of the system. In one embodiment, the authorities are local or state police. In one embodiment, the information is transmitted to insurance companies or other agencies such as the National Highway Traffic Safety Administration (NHTSA).

Further, the information can be stored for use in later investigations and studies. For example, road hazards such as potholes and flooding can be detected by the cameras in the vehicle and reported to road safety authorities. Witnesses may be located by searching recorded information taken in the vicinity of crimes and incidents around the time of the occurrence of such crimes and incidents.

Further, the recorded information can be used in prosecution of traffic and other infractions if steps are taken to certify the authenticity of the information including chain of custody as required by the authorities that will use the information in this manner.

The information may be encrypted using now-known of later standardized cryptography protocols.

The infractions and occurrences that may be observed and/or detected by analysis of the stored information include the following:
License plate tracking;
Driving with an expired registration;
Facial recognition/tracking;
Traffic flow data;
Detection of drivers under the influence;
Traffic infractions/crimes;
Defective/illegal equipment;
Road accidents and/or road hazards;
Public safety hazards;
Littering;
Mobile phone usage while operating a motor vehicle;
Illegal lane changing including illegal passing of a vehicle in motion;
Domestic violence;
Road-rage;
Following another vehicle at an unsafe distance;
Speeding;
Reckless driving and reckless endangerment;
Other specific use case scenarios can be detected upon request.

The recorded information and the analysis of such information by the programmed computer may be transmitted to local authorities continuously or upon demand. The recorded information and the analysis of such information by the programmed computer may be provided to local authorities by batch. The authorities may also receive signals indicative that certain information requires immediate attention, such as traffic accidents or public safety hazards.

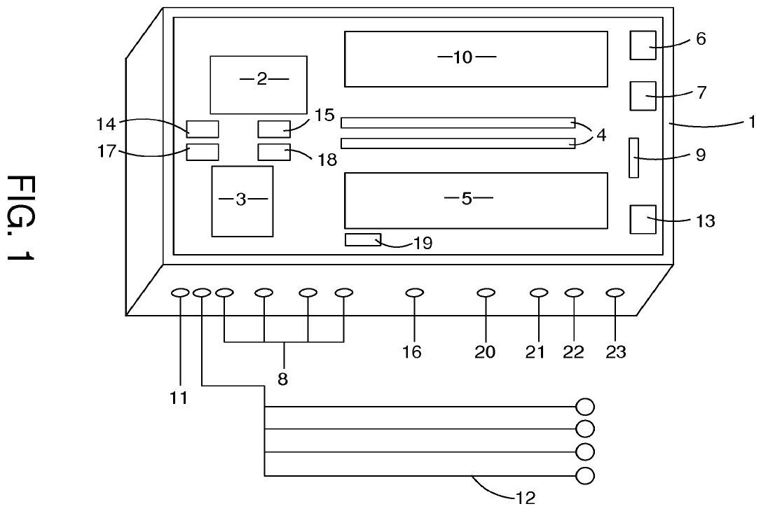

Turning to FIG. 1, a schematic of a system programmed computer in a vehicle is shown. The system includes a case 1 enclosing a CPU 2, a power supply 3, RAM 4, memory 5, system fan 10 and power connection 11. In the embodiment seen in FIG. 1, the system further comprises a cellular modem 6, a wireless network module 7, a plurality of camera connections 8 to which a plurality of cameras 12 are attached, a plurality of antennas 9, a Bluetooth® module 13, a GPS module 14, accelerometer/gyroscopic module 15, GPS antenna 16, radar 17 and radar connection 21, laser 18 and laser connection 22 and LIDAR 19 and LIDAR connection 23. The system may further comprise hard wired connection 20 for a mobile communications device.

In one embodiment, the cameras, sensors and memory are located resident in the vehicle. In this embodiment, the programmed computer is located remotely from the vehicle.

In one embodiment, the memory 5 comprises a hard drive. In one embodiment, the memory 5 comprises a solid state drive. In one embodiment, one or more of the plurality of cameras 12 comprise high resolution cameras.

The various elements of the system are in communication with each other according to standard protocols and information is stored and received according to standard data file types.

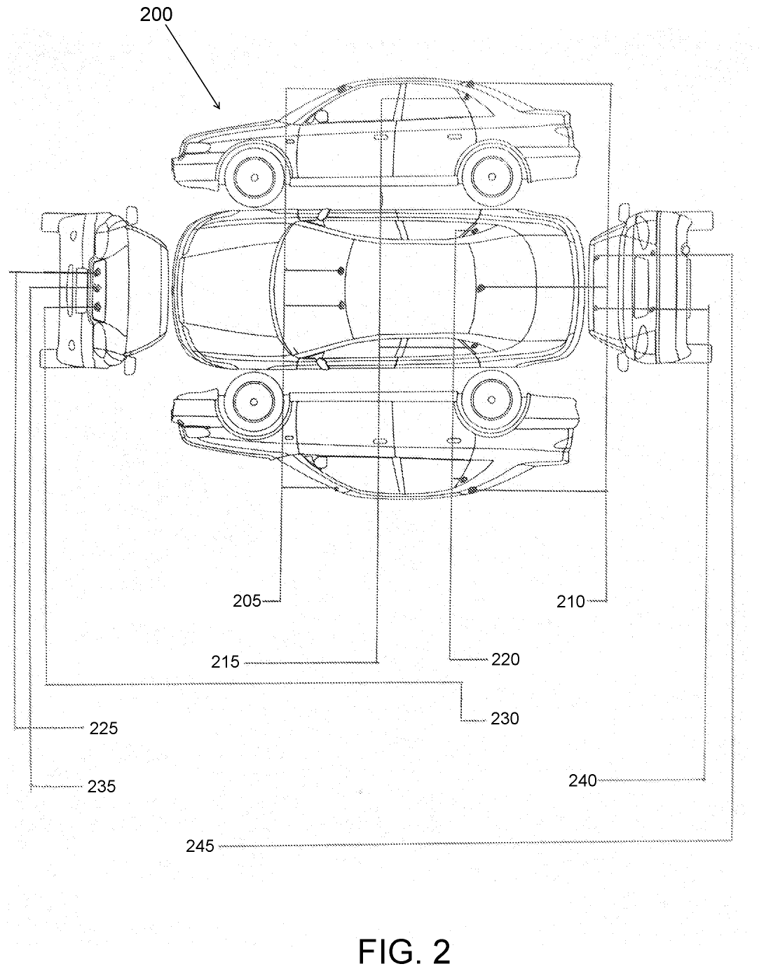

FIG. 2 is an orthogonal projection of a vehicle showing placement of cameras and modules according to one embodiment of the invention. Vehicle 200 is shown in top view, right side view, left side view, rear view and front view. Front camera 205, rear camera 210, side camera (driver's side) 215, side camera (passenger's side) 220, laser 225, LIDAR 230, radar 235, GPS antenna 240 and cellular antenna 245 are mounted to vehicle 200 as shown in this embodiment. Multiple cameras and sensors may be used as desired. In one embodiment, infrared lamp modules may be integrated with one or more of front camera 205, rear camera 210, side camera (driver's side) 215 and side camera (passenger's side) 220.

### Examples

A vehicle with the system as described installed may be stopped at a red light in lane number 2 of a 6-lane intersection. A vehicle operated by a third party may approach from the rear in lane number 1 and proceed to pass through the red light with stopping. The system may record the event from rear, side, and front mounted cameras. Video recordings of the event with time stamps can be stored in memory. The programmed computer can analyze the event by combining the video records according to the time stamps and obtain a sequence of events that detail the running of the red light by the third party vehicle. An applicable agency may receive notification of the infraction in video and data formats showing the third party vehicle approaching form the rear camera view. Video from the side camera view may show the third party vehicle as it passes the vehicle in which the system is installed. The video may then show the third party vehicle from the front camera view showing the third party vehicle committing the infraction of running a red light. The video from the various cameras can be combined according to time stamps to produce one cohesive video. The agency can then decide whether to pursue a traffic violation with the owner of the third party vehicle.

A vehicle with the system installed may collect information in what is believed to be a parking violation. As an example, the programmed computer may determine a first line in a frame where the line represents a nominal orientation of the parking area at issue. The programmed computer may detect the presence of a vehicle in the parking area. The programmed computer may further determine a second line in the frame where the line represents the orientation of the detected vehicle. The programmed computer may compute an angle between the first and second lines. Based on this computation, the programmed computer may determine whether the detected vehicle is violating a parking regulation based on the computed angle. The videos and computational analysis can be provided to local authorities who will determine whether to pursue a parking violation with the owner of the vehicle.

While the invention has been described with reference to a particular embodiment and application, numerous variations and modifications could be made thereto by those skilled in the art without departing from the spirit and scope of the invention as claimed. Accordingly, the scope of the invention should be determined with reference to the claims.

What is claimed is:

1. A computerized system for detection of traffic infractions utilizing artificial intelligence, comprising:
a first vehicle, the first vehicle comprising an interior and an exterior;
a plurality of cameras mounted on the first vehicle, the plurality of cameras facing away from the interior of the first vehicle, the plurality of cameras recording one or more streams of video information in digital format;
a plurality of sensors mounted on the first vehicle, the one or more sensors recording one or more streams of sensor information in digital format;
a medium for storing data in digital format located in the interior of the first vehicle, the medium in communication with the plurality of cameras and the plurality of sensors;
a non-transitory storage device embodying one or more routines operable to detect objects using artificial neural networks, the non-transitory storage device comprising a receiver module, a detector module and a logic module; and
a CPU in communication with the non-transitory storage device, the CPU operable to execute the one or more routines embodied in the non-transitory storage device,
wherein the one or more streams of video information comprise activities of third party vehicles and persons located on the exterior of the first vehicle,
wherein data in digital format that are stored in the medium for storing data are transmitted to the receiver module,
wherein the receiver module detects one or more images in received data in digital format that comprises video information,
wherein the detector module selects one or more events of interest from the received data in digital format that comprises video information,
wherein the logic module determines if the one or more events of interest that were selected by the detector module comprise one or more actionable events performed by the third party vehicles and persons.

2. The system of claim 1, wherein one or more of the cameras comprise high resolution video cameras.

3. The system of claim 1, wherein the one or more sensors comprise radar, laser, LIDAR or combinations thereof.

4. The system of claim 1, wherein the one or more actionable events comprises one or more traffic violations.

5. The system of claim 4, wherein the one or more traffic violations comprise driving with an expired registration, driving under the influence, one or more crimes, defective equipment, illegal equipment, road accidents, public safety hazards, littering, mobile phone usage while operating a motor vehicle, illegal lane changing, illegal passing of a vehicle in motion, domestic violence, road-rage, following another vehicle at an unsafe distance, speeding, reckless driving, reckless endangerment and combinations thereof.

6. The system of claim 1, wherein the video information identified to comprise one or more actionable events is communicated to a local authority.

7. The system of claim 6, wherein the video information and the sensor information are time stamped, wherein sensor information corresponding by time stamp to the video information that is identified to comprise one or more actionable events is communicated to the local authority.

8. The system of claim 1, wherein the actionable events comprise license plate tracking, facial recognition, facial tracking, traffic flow data and combinations thereof.

9. The system of claim 1, wherein the non-transitory storage device further comprises a training module, wherein the training module trains the artificial neural networks to detect actionable events based on previously manually classified images or series of images.

10. The system of claim 9, wherein the previously classified images or series of images are manually classified according to laws, regulations and combinations thereof.

11. The system of claim 10, wherein the previously classified images or series of images have been manually classified to comprise traffic violations.

12. The system of claim 1, wherein the non-transitory storage device and the CPU are located in the interior of the first vehicle.
